(19) United States
(12) Patent Application Publication
(10) Pub. No.: US 2016/0189108 A1
(43) Pub. Date: Jun. 30, 2016

(54) CALENDAR WITH CUSTOMER RELATIONSHIP MANAGEMENT (CRM) GANTT CHART INTEGRATION

(71) Applicant: SugarCRM Inc., Cupertino, CA (US)

(72) Inventors: Charles Godewyn, Phoenix, AZ (US); Ing-Marie Jonsson, Los Gatos, CA (US); Maria Zolotova, Mountain View, CA (US)

(21) Appl. No.: 14/586,588

(22) Filed: Dec. 30, 2014

(51) Int. Cl. G06Q 10/10; G06Q 30/00

(52) U.S. Cl. CPC G06Q 10/1093; G06Q 30/01

(57) ABSTRACT

Embodiments of the invention for Gantt chart CRM and calendar data integration in a CRM application. A method for Gantt chart CRM and calendar data integration in a CRM application includes defining in a database of a CRM application phases of different pipelines for respectively different target customers, each of the phases requiring a specific number of days for completion. The method further includes associating in the database different tasks to be performed in connection with the different phases of different ones of the different pipelines. The method yet further includes displaying in a user interface of the CRM application a Gantt chart of the different sales pipelines and selecting a portion of the Gantt chart reflective of a date range. Finally, the method includes additionally displaying in the Gantt chart, selected ones of the different tasks associated with ones of the different phases of the selected portion.

### BACKGROUND OF THE INVENTION

1. Field of the Invention

The present invention relates to sales pipeline management in a customer relationship management (CRM) application and more particularly to pipeline visualization within a CRM application.

2. Description of the Related Art

CRM refers to the interaction that a business entity enjoys with its customers, whether the business entity provides sales or services to the customer. CRM is often thought of as a business strategy that enables business managers to understand the customer, to retain customers through better customer experience, to attract new customers, increase profitability and to decrease customer management costs. In real terms, however, CRM systems are used specifically to manage business contacts, clients, contract wins and sales leads. As such, CRM solutions provide the end user with the customer business data necessary to provide services or products desired by the customers, to provide better customer service, to cross-sell and to up-sell more effectively, to close deals, retain current customers and understand the identity of the customer.

Central to a CRM solution is the notion of a “business opportunity”. A business opportunity in the context of CRM is synonymous with a “sales opportunity” as an element of the “sales pipeline”. A sales pipeline describes an approach to selling, founded on the underlying principles of the sales process. More particularly, the sales pipeline describes the individual steps salespeople undertake from initial contact with a potential customer, or “prospect”, to qualifying that prospect into a lead, and further validating that lead into a sales opportunity followed through the different stages until closed. A lead pipeline, in turn, is the more granular process of validating a prospect from initial contact through prospect to lead. With respect to the former, all sales opportunities arranged along each of the sales steps that make up the sales process represented by the sales pipeline. Thus, a business opportunity is a qualified and validated lead for a potential sale of a product or service.

The sales pipeline generally is considered a specific case of a project requiring a set of steps to drive the project to completion in the same way a construction project requires a set of steps to drive the completion of the construction of a structure. Typically, projects are visualized utilizing a Gantt chart visualization. A Gantt chart is a type of bar chart that illustrates a project schedule by showing the start and finish dates of the various terminal elements and summary elements of a project. Terminal elements and summary elements include the work breakdown structure of the project. Gantt charts also may visualize the dependency relationships between activities of the project. Yet further, Gantt charts oftentimes show a contemporaneous status of the project using percent-complete shadings and a vertical line drawn through the Gantt chart representative of a current date.

CRM applications frequently utilize the Gantt chart visualization in order to visualize different pipelines, such as a sales pipeline or lead pipeline. However, the use of a Gantt chart visualization in a typical CRM system is limited to the visualization of a pipeline. The various and sundry tasks implicated by the pipeline are treated separately from other tasks of the end user of the CRM application not necessarily linked to any pipeline. In the latter instance, the general tasks of the CRM system end user are visualized in a calendar within a calendaring and scheduling (C&S) portion of a CRM system. Thus, a complete view of the daily tasks scheduled for an end user of a CRM system require the end user to mentally integrate the tasks referenced in the Gantt chart visualization of the pipeline of the end user with the tasks of a separate C&S component of the CRM system, or in many cases of a completely separate computer program exclusive of the CRM system.

### BRIEF SUMMARY OF THE INVENTION

Embodiments of the present invention address deficiencies of the art in respect to Gantt chart visualization of a pipeline and provide a novel and non-obvious method, system and computer program product for Gantt chart CRM and calendar data integration in a CRM application. In an embodiment of the invention, a method for Gantt chart CRM and calendar data integration in a CRM application is provided. The method includes defining in a database of a CRM application multiple different phases of multiple different pipelines for respectively different customers, each of the phases requiring a specific number of days for completion. The method further includes associating in the database different tasks to be performed in connection with different ones of the different phases of different ones of the different pipelines. The method yet further includes displaying in a user interface of the CRM application a Gantt chart of the different pipelines and selecting a portion of the Gantt chart reflective of a date range. Finally, the method includes additionally displaying in the Gantt chart, selected ones of the different tasks associated with ones of the different phases of the selected portion.

In one aspect of the embodiment, one of the different phases of a corresponding one of the pipelines is updated, the updating changing the number of days required to complete the one of the different phases. Consequently, the method includes adjusting a date for each of the tasks not yet completed and associated with the one of the different phases to account for the updating of the one of the different phases, and refreshing a display of the Gantt chart to account for the updating of the of the one of the different phases. In another aspect of the embodiment, a new task is added and associated in the database with one of the different phases. Thereafter, an update to the one of the different phases can be detected. In response, the method includes displaying in the user interface of the CRM application a correlation between the added new task and the update to the one of the different phases.

In another embodiment of the invention, a data processing system is configured for Gantt chart CRM and calendar data integration in a CRM application. The system includes a host computing system that includes one or more computers each with memory and at least one processor. The system also includes a database storing CRM data defining multiple different phases of multiple different pipelines for respectively different customers, each of the phases requiring a specific number of days for completion. The system yet further includes a CRM application executing in the memory of the host computing system utilizing the CRM data. Finally, the system includes a Gantt chart and calendar data integration module coupled to the CRM application. The module includes program code enabled upon execution in the memory of the host computing system to associate in the database different tasks to be performed in connection with different ones of the different phases of different ones of the different pipelines, to display in a user interface of the CRM application a Gantt chart of the different sales pipelines, to select a portion of the Gantt chart reflective of a date range, and to additionally display in the Gantt chart, selected ones of the different tasks associated with ones of the different phases of the selected portion.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for Gantt chart CRM and calendar data integration in a CRM application;

FIG. 2 is a schematic illustration of a CRM data processing system configured for Gantt chart CRM and calendar data integration in a CRM application; and,

FIG. 3 is a flow chart illustrating a process for Gantt chart CRM and calendar data integration in a CRM application.

### DETAILED DESCRIPTION OF THE INVENTION

Embodiments of the invention provide for Gantt chart CRM and calendar data integration in a CRM application. In accordance with an embodiment of the invention, multiple different pipelines for respectively different target customers can be defined within different records of a database of a CRM application, each of the pipelines including different phases of a sales process or lead process. Each of the different phases as defined in corresponding ones of the different records can be scheduled to require a particular duration of days to complete so that the sum of all durations of days to complete of all of the different phases of a sales pipeline reflects at most a prospective duration of days required to complete the pipeline for the target lead or target customer as the case may be. Subsequently, the actual progress of the pipeline can be tracked so as to cause an adjustment of the duration of days to complete the pipeline dependent upon an actual number of days consumed in completing one or more of the different phases.

Notably, one or more tasks can be specified for each of the different phases for each of the pipelines. In this regard, the tasks can include phone calls, messages, meetings, to-dos and follow up tasks, to name only a few. Each of the tasks can be stored as a record in the database and can be associated in the record with a particular one of the different phases of a particular one of the different pipelines. Each of the tasks further can be scheduled for a particular date. Thereafter, an integrated user interface of the CRM application can be loaded into memory and displayed so as to include a Gantt chart representation of a contemporaneous status of each pipeline including the respectively different phases contemporaneously scheduled for particular dates of a calendar.

A portion of the Gantt chart representation for a specified date range can be selected in the user interface, the selected portion including one or more of the different phases for each of the different pipelines. Also, the selected portion can include and those of the tasks associated with the selected portion of the Gantt chart representation. The tasks associated with the selected portion then can be displayed in connection with the display of the portion of the Gantt chart representation. Consequently, an integrated view of the tasks required to be performed on a given date or dates of a calendar can be readily associated with a contemporaneous view of the pipelines for each of the target customer. Further, a correlation can be computed as between tasks performed and an actual completion of a corresponding one of the different phases of a corresponding one of the pipelines.

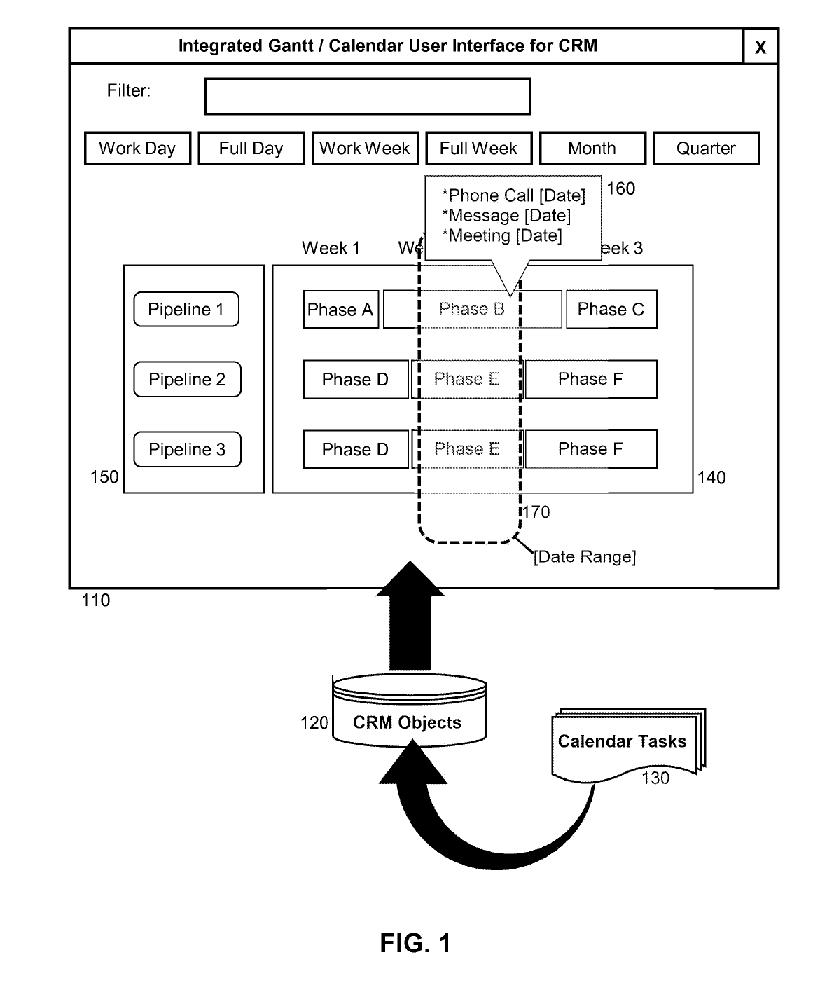

In further illustration, FIG. 1 pictorially shows a process for Gantt chart CRM and calendar data integration in a CRM application. As shown in FIG. 1, an integrated Gantt/Calendar user interface 110 for a CRM application can be presented in a display of a computer. The user interface 110 can include a display of Gantt charts 140 in which one or more Gantt charts 140 for different phases 120 of one or more specified pipelines 150 can be presented. The specified pipelines 150 further can be limited according to a specified keyword filter presented within the user interface 110. Alternatively, the display of the Gantt charts 140 for the pipelines 150 can be limited according to pre-programmed date ranges such as a single work day, a full day, a single work week, a full week, a month or quarter view. As yet another alternative, one or more of the pipelines 150 can be aggregated together so that each phase of the aggregated one of the pipelines 150 is of an average duration of counterpart phases of a selection of the pipelines 150.

Of note, a portion 170 of each of the Gantt charts 140 can be selected. In this regard, the portion 170 selected can be representative of a data range or specific date. The portion 170 can be manually selected utilizing a mouse pointer or keyboard controlled pointer, for example. Once selected, calendared tasks 130 corresponding to those of the phases 120 of the phases 120 of the selected pipelines 150 included in the portion 170 can be presented in an additional display 160 in connection with the Gantt charts 140. In this way, the display of the temporally relevant ones of the calendared tasks 130 can be integrated with the temporally relevant ones of the phases 120 of the selected portions 170 of the pipelines 150 in an integrated way.

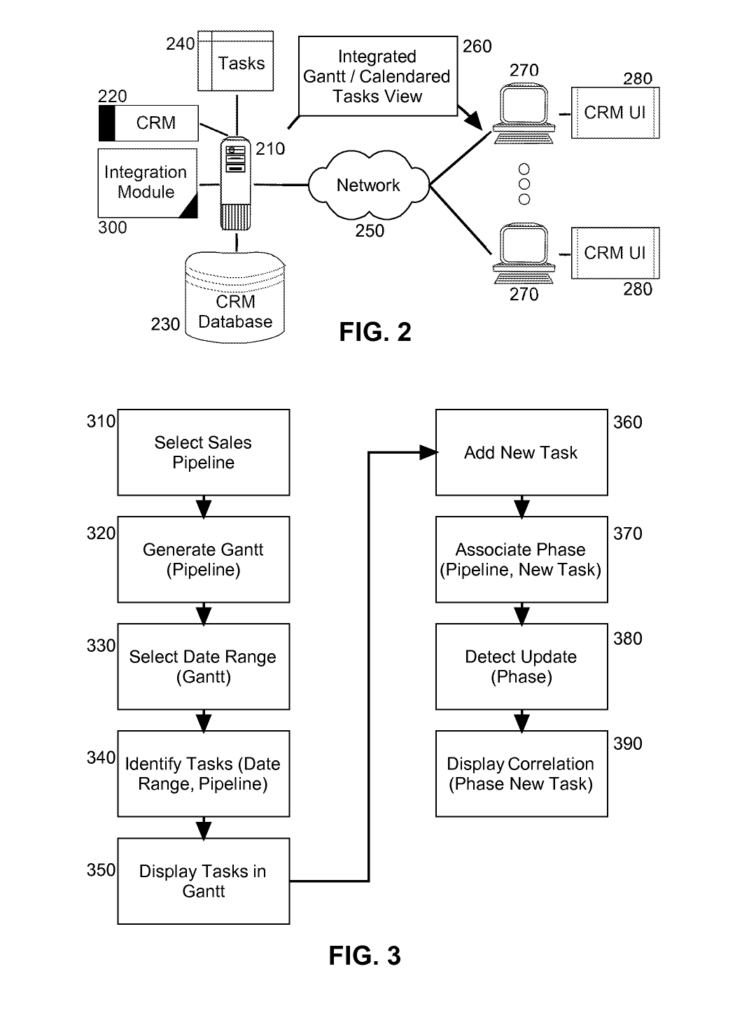

The process described in connection with FIG. 1 can be implemented in a CRM data processing system. In yet further illustration, FIG. 2 schematically shows a CRM data processing system configured for Gantt chart CRM and calendar data integration in a CRM application. As shown in FIG. 2, a host computing system 210 that includes one or more computers, each with memory and at least one processor, can support the execution of a CRM application 220 utilizing CRM objects in a CRM database 230. Access to the CRM objects of the CRM database 230 can be afforded by the CRM application to different client computers 270 over a computer communications network 250. In this regard, different end users can access the CRM objects of the CRM database 230 through respectively different user interface displays of the CRM application 220.

The CRM objects of the CRM database 230 can be organized for different target customers in correspondingly different pipelines, each pipeline being defined by different phases in sequence or overlapping such that each different phase requires a number of days to complete and the total number of days required to complete the entire pipeline is equal to or less than the sum of the total number of days required to complete each phase of the pipeline. Further, each phase of each pipeline can be scheduled in connection with a particular calendar date or range of dates so as to provide for a calendared collection of pipelines. Finally, different calendared tasks 240 can be associated with different ones of the CRM objects in the CRM database 230 corresponding to the phases of the pipeline.

Notably, an integration module 300 can be coupled to the CRM application 220. The module can include program code enabled upon execution in the memory of the host computing system to respond to a date or date range selection of a portion of one or more Gantt charts displayed in a CRM user interface 280 by identifying the phases of those of the pipelines present within the portion and also any associated ones of the tasks 240. The program code of the module 300 additionally is enabled to present an integrated view 260 of the selected portion of the Gantt charts along with the associated tasks in the CRM user interface 280.

In even yet further illustration of the operation of the integration module 300, FIG. 3 is a flow chart illustrating a process for Gantt chart CRM and calendar data integration in a CRM application. Beginning in block 310, a pipeline can be selected that includes a multiplicity of different phases of the pipeline. In block 320, a Gantt chart can be generated for the selected pipeline. In block 330, a portion of the Gantt chart can be selected. The portion selected can reflect a specific calendar date or date range. In response, in block 340 one or more tasks associated with phases of the pipeline present within the selected portion can be identified. Thereafter, in block 350 an integrated view of the identified tasks and portion of the Gantt chart can be presented in a user interface to the CRM application.

In block 360, a new task can be added to the CRM application. The new task can include, for example, a new phone call, message, meeting or follow-up. In block 370, the new task can be associated with a particular phase of a particular pipeline of a particular target customer reflected in one or more CRM objects in a CRM database of the CRM application. In block 380, an update to the particular phase can be detected resulting in a change in a number of days required to complete the particular phase and therefore, in an expected date of completion of the particular phase. In response, in block 390, a correlation can be displayed in the integrated view illustrating the correlation between the new task and the change in the particular phase. Optionally, the correlation between the new task and the change in the particular phase can be utilized subsequently in the particular phase of a different pipeline so as to prompt an end user to schedule the new task in connection with the particular phase present in the different pipeline.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for Gantt chart customer relationship management (CRM) and calendar data integration in a CRM application, the method comprising:
defining in a database of a CRM application multiple different phases of multiple different pipelines for respectively different target customers, each of the phases requiring a specific number of days for completion;
associating in the database different tasks to be performed in connection with different ones of the different phases of different ones of the different pipelines;
displaying in a user interface of the CRM application a Gantt chart of the different pipelines;
selecting a portion of the Gantt chart reflective of a date range; and
additionally displaying in the Gantt chart, selected ones of the different tasks associated with ones of the different phases of the selected portion.

2. The method of claim 1, further comprising:
updating one of the different phases of a corresponding one of the pipelines, the updating changing the number of days required to complete the one of the different phases;
adjusting a date for each of the tasks not yet completed and associated with the one of the different phases to account for the updating of the one of the different phases; and,
refreshing a display of the Gantt chart to account for the updating of the one of the different phases.

3. The method of claim 1, further comprising
adding a new task and associating the new task in the database with one of the different phases;
detecting an update to the one of the different phases; and,
displaying in the user interface of the CRM application a correlation between the added new task and the update to the one of the different phases.

4. The method of claim 1, wherein the task is a task selected from the group consisting of a phone call, a meeting and a message.

5. The method of claim 1, wherein the pipeline is a sales pipeline.

6. The method of claim 1, wherein the pipeline is a lead pipeline.

7. A data processing system configured for Gantt chart customer relationship management (CRM) and calendar data integration in a CRM application, the system comprising:
a host computing system comprising one or more computers each with memory and at least one processor;
a database storing CRM data defining multiple different phases of multiple different pipelines for respectively different target customers, each of the phases requiring a specific number of days for completion;
a CRM application executing in the memory of the host computing system utilizing the CRM data; and,
a Gantt chart and calendar data integration module coupled to the CRM application, the module comprising program code enabled upon execution in the memory of the host computing system to associate in the database different tasks to be performed in connection with different ones of the different phases of different ones of the different pipelines, to display in a user interface of the CRM application a Gantt chart of the different pipelines, to select a portion of the Gantt chart reflective of a date range, and to additionally display in the Gantt chart, selected ones of the different tasks associated with ones of the different phases of the selected portion.

8. The system of claim 7, wherein the program code is further enabled to:
update one of the different phases of a corresponding one of the pipelines, the updating changing the number of days required to complete the one of the different phases;
to adjust a date for each of the tasks not yet completed and associated with the one of the different phases to account for the updating of the one of the different phases; and,
to refresh a display of the Gantt chart to account for the updating of the one of the different phases.

9. The system of claim 7, wherein the program code is further enabled to:
add a new task and associate the new task in the database with one of the different phases;
detect an update to the one of the different phases; and,
display in the user interface of the CRM application a correlation between the added new task and the update to the one of the different phases.

10. The system of claim 7, wherein the task is a task selected from the group consisting of a phone call, a meeting and a message.

11. The system of claim 7, wherein the pipeline is a sales pipeline.

12. The system of claim 7, wherein the pipeline is a lead pipeline.

13. A computer program product for Gantt chart customer relationship management (CRM) and calendar data integration in a CRM application, the computer program product comprising a computer readable storage medium having program instructions embodied therewith, the program instructions executable by a device to cause the device to perform a method comprising:
defining in a database of a CRM application multiple different phases of multiple different pipelines for respectively different target customers, each of the phases requiring a specific number of days for completion;
associating in the database different tasks to be performed in connection with different ones of the different phases of different ones of the different pipelines;
displaying in a user interface of the CRM application a Gantt chart of the different pipelines;
selecting a portion of the Gantt chart reflective of a date range; and
additionally displaying in the Gantt chart, selected ones of the different tasks associated with ones of the different phases of the selected portion.

14. The computer program product of claim 13, wherein the method further comprises:
updating one of the different phases of a corresponding one of the pipelines, the updating changing the number of days required to complete the one of the different phases;
adjusting a date for each of the tasks not yet completed and associated with the one of the different phases to account for the updating of the one of the different phases; and,
refreshing a display of the Gantt chart to account for the updating of the one of the different phases.

15. The computer program product of claim 13, wherein the method further comprises:
adding a new task and associating the new task in the database with one of the different phases;
detecting an update to the one of the different phases; and,
displaying in the user interface of the CRM application a correlation between the added new task and the update to the one of the different phases.

16. The computer program product of claim 13, wherein the task is a task selected from the group consisting of a phone call, a meeting and a message.

17. The computer program product of claim 13, wherein the pipeline is a sales pipeline.

18. The computer program product of claim 13, wherein the pipeline is a lead pipeline.
